(19) United States
(12) Patent Application Publication
(10) Pub. No.: US 2008/0085025 A1
(43) Pub. Date: Apr. 10, 2008

(54) Case For An Audio Or Video Player

(76) Inventor: Bernard Findley, Newtown, CT (US)

Correspondence Address: ST. ONGE STEWARD JOHNSTON & REENS, LLC, 986 BEDFORD STREET, STAMFORD, CT, 06905-5619, US

(21) Appl. No.: 11/866,480

(22) Filed: Oct. 3, 2007

Related U.S. Application Data
(60) Provisional application No. 60/849,958, filed on Oct. 6, 2006.

(51) Int. Cl. H04R 1/02; B65D 6/00

(52) U.S. Cl. 381/334; 206/320

(57) ABSTRACT

The invention relates to a case for an audio or video player having a front cover and a back cover, each having an inside wall and an outside wall. A speaker is placed between the inside and outside walls of the front cover, a cord is placed between the inside walls for connecting the speaker to the player through the inside wall of the front cover, and the speaker includes an output facing toward the outside wall. The speaker facing outwards permits the player to be heard when the case is closed without sacrificing sound quality.

### CROSS-REFERENCE TO RELATED APPLICATIONS

The present application claims the benefit under 35 U.S.C. §119(e) of the U.S. Provisional Patent Application Ser. No. 60/849,958, filed on Oct. 6, 2006, the content of which is incorporated herein by reference.

### FIELD OF THE INVENTION

The invention relates to a case for an audio and/or video player.

### BACKGROUND OF THE INVENTION

Portable audio or video players are known to typically allow a user to carry music and/or video wherever he/she may be, such as on a bus, at the airport, in an elevator, and other areas where transporting a complete stereo or television system complete would be difficult. In some situations, the complete stereo system may include speakers, a receiver, a CD player/burner, an equalizer, and surround sound and the complete television system may include a monitor, a DVD player/burner, and surround sound. A portable audio/video player is generally described to be a CD player, cassette player, iPod music player, MP3 player, DVD player, and the like.

Although the portable audio/video player has the advantage of being small relative to a complete stereo/television system, the sound output of the audio/video player is usually inferior to the complete stereo system. Despite the inferior sound output, audio players are believed to have gained popularity due perhaps to their ability to store large amounts of songs, as in the case of the iPod or MP3 players. As the popularity increases, the prices generally increase as well. Further, the portable video player may have gained popularity, despite inferior sound, due to the advancements in the DVD to hold more video with higher resolution and the ability of the portable video player to be able to display the high resolution.

In view of the foregoing, cases are typically purchased because the cases protect the portable audio players. In some instances, cases have built in speakers to amplify the sound of the audio players. In other instances, the audio/video player does not have speakers and relies upon user-supplied headphones for the user to hear the music. Introducing headphones may also introduce another disadvantage, which is the cord that connects the headphones to the audio player and where the cord may become tangled or caught up with other objects, such as a jacket, a door, or anything that the user may encounter as the user moves about. One way to overcome the problems associated with the cord is to use the audio/video player when the user is stationary. However, this detracts from the portability of the audio/video player.

Although some cases have speakers, these cases often must be in the open position in order to have the best sound available. With respect to the video player, the case often must be in the open position in order to view the video. In the open position, the case may be difficult to transport and this also detracts from the portability of the audio/video player.

In addition, with the various types of audio and video players, and with many manufacturers making them, it may be difficult for case manufacturers to provide a case that universally fits two or more of the players. As a result a case made to fit around more two or more players usually results in an improper fit for at least one of the players. However, providing a case for each player to ensure a proper fit may be too cumbersome and expensive, especially if the audio or video player changes from year to year or from version to version.

U.S. Pat. No. 7,039,210 to Holland seems to relate to a brief case that includes a loudspeaker, where the brief case is large enough to hold a variety of portable audio players.

U.S. Pat. No. 6,981,085 to Tree seems to relate to a case for portable electronic devices, such as an audio player, where the case includes a speaker with a connection port for attachment to the electronic device. However, Tree does not seem to relate to a case with a rigid material to protect the electronic device or an internal cord to connect the device with the speaker. In fact, Tree seems to have a cord outside of the case, rather than being contained within the case, and this may be a hindrance to the user. Also, the speaker may need to be exposed in order to hear the audio player.

U.S. Publication 2006/0016810 to Liporice may disclose a case for holding an audio player but there is no mention of a cord for attachment of the audio player with a speaker.

What is desired, therefore, is a case that allows a user to move in a more unencumbered manner. Another desire is a case that protects the audio and/or video player better than traditional cases without sacrificing sound quality.

### SUMMARY OF THE INVENTION

It is therefore an object of the invention to provide a case that permits the player to be heard with the case closed without sacrificing sound quality.

Another object is a case that places all encumbrances inside of the case for reducing interference or tangling with other articles.

These and other objects of the invention are achieved by a case for an audio or video player having a front cover and a back cover, each having an inside wall and an outside wall. A speaker is placed between the inside and outside walls of the front cover, a cord is placed between the inside walls for connecting the speaker to the player through the inside wall of the front cover, and the speaker includes an output facing toward the outside wall. The speaker facing outwards permits the player to be heard when the case is closed without sacrificing sound quality.

In some embodiments, an adapter is attached to the cord for coupling the player to the cord, which is particularly helpful when the cord does not fit directly into the player. In other embodiments, a holder is attached to the inside wall of the back cover for holding the player against the back cover. In a further embodiment, a headphone jack is attached to the outside wall of the front cover for accommodating a set of headphones.

In another embodiment, the case has a layer of insulating material for reducing electric conductivity. The layer is located on either the inside or outside wall of each cover.

In yet another embodiment, a second speaker is placed between the inside and outside walls of the front cover and having an output facing toward the inside wall. This allows the player to be heard with the case opened without sacrificing sound quality.

To snugly hold the player within the case, a greatest distance between the front cover and the back cover from the player is less than 1 inch. In a further embodiment, the front and back covers each have rounded corners and a bowed outside wall for conforming to a shape and size of the player.

In another aspect of the invention, a case for an audio or video player includes a front cover and a back cover, each having an inside wall and an outside wall. The case also has a speaker placed between the inside and outside walls of the front cover, the speaker having an output facing toward the outside wall, a holder attached to the inside wall of the back cover for securing the player, a power supply attached to the inside wall of the front cover for powering the speaker, a cord extending from the power supply to between the inside walls for connecting the speaker to the power supply, the speaker connected to the power supply for transmitting sound from the player, and a closer for securing the inside walls in a face to face position.

In a further embodiment, the front and back covers are each curved outwardly away from the inside wall, thereby defining an interior in which the player is placed.

In another aspect of the invention, a method for providing a case for an audio or video player includes the steps of providing a front cover and a back cover, each having an inside wall and an outside wall. The method also places a speaker between the inside and outside walls of the front cover and faces an output of the speaker toward the outside wall. Moreover, the method attaches a holder to the inside wall of the back cover for securing the player and attaches a power supply to the inside wall of the front cover for powering the speaker.

The method also includes the steps of extending a cord from the power supply to between the inside walls for connecting the speaker to the power supply, connecting the power supply to the speaker for transmitting sound from the player, and connecting the inside walls together with a closer, wherein the closer brings the inside walls together for defining the case in a closed position face to face position and permitting the inside walls to be separated from each other for defining the case in an open position.

### BRIEF DESCRIPTION OF THE DRAWINGS

FIG. 1 depicts the case for a music player in accordance with the invention.

FIG. 2 depicts the case of FIG. 1 in an open position.

FIG. 3 depicts a player inserted into the case of FIG. 1.

FIG. 4 depicts the case of FIG. 1 in use.

FIG. 5 depicts an inside view of the case of FIG. 1.

FIG. 6 depicts another embodiment of the case of FIG. 1.

FIG. 7 depicts a kit of the cases shown in FIG. 1.

FIG. 8 depicts a method of providing the case of FIG. 1.

### DETAILED DESCRIPTION OF THE INVENTION

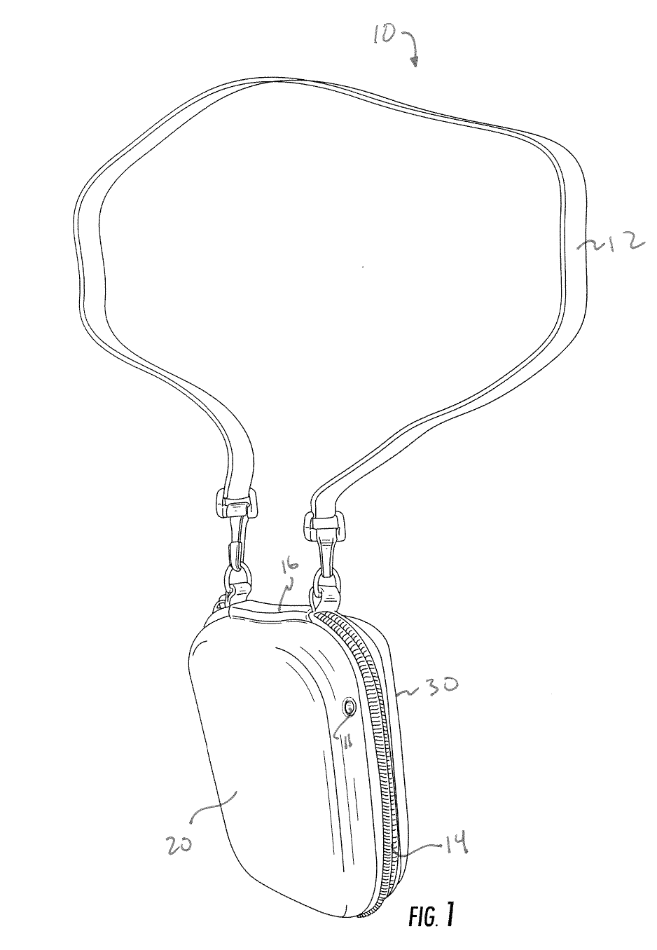

FIG. 1 depicts case 10 in a closed position. As shown, case 10 includes carrying strap 12, front cover 20, back cover 30, hinge 16 for connecting front and back covers together, and closer 14 for bringing front and back covers together. Although closer 14 is depicted to be a zipper, other embodiments use hook and loop fasteners as closer 14. In some embodiments, closer 14 is a button. As shown, hinge 16 is a continuation of the fabric of the outside of front cover 20 to back cover 30. In another embodiment, hinge 16 is hardware, such as a piano hinge, door hinge, and the like. In further embodiments, closer 14 continues all around the peripheries of the covers 20, 30. In the case of the closer being a zipper, the zipper goes all around the entire peripheries, thereby making the covers separable from one another.

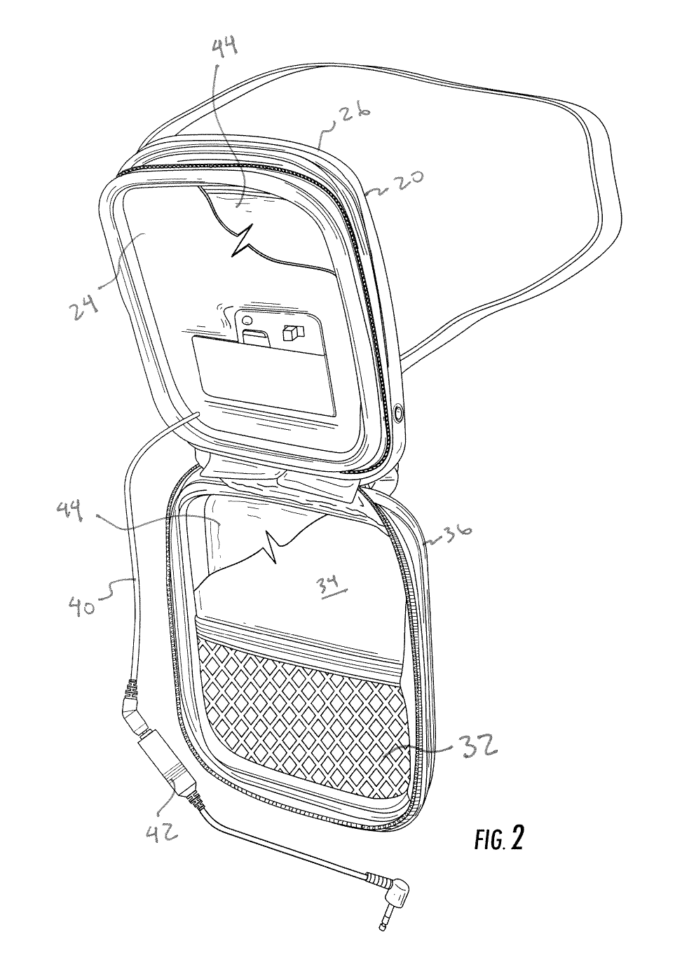

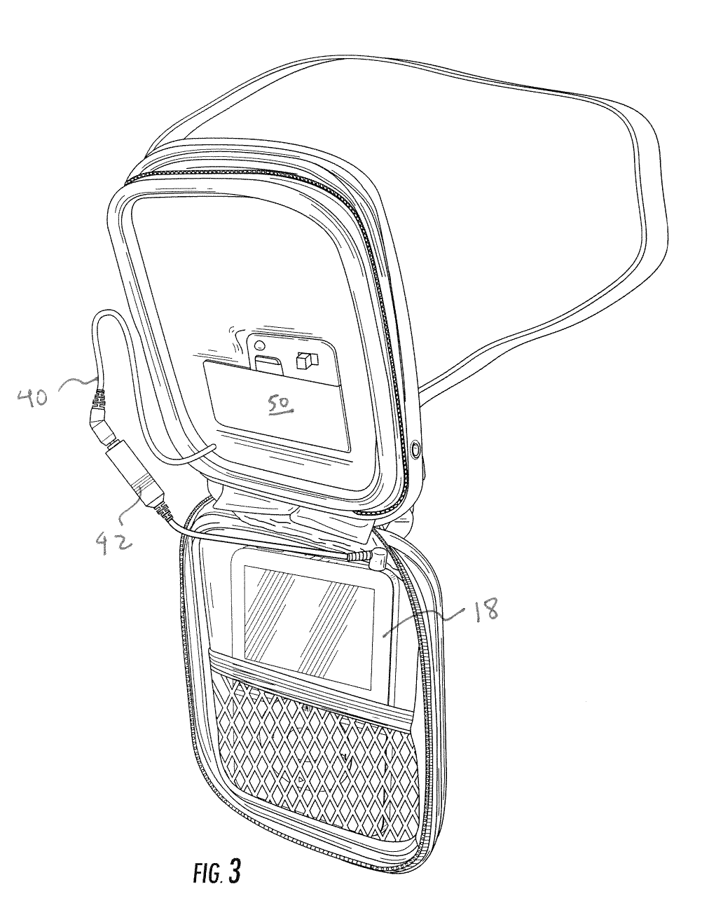

FIGS. 2 and 3 show case 10 in an open position, where back cover 30 includes holder 32 for placement of audio/video player 18 (hereinafter called “player”). In some embodiments, holder 32 is a stretchable, elastic netting such that player 18 is held snugly in place against back cover 30. In other embodiments, back cover 30 is lined with felt, leather, or other material for cushioning and reducing scuffing to player 18.

Cord 40 extends from inside front cover 20 to player 18 for connecting player 18 to power source 50 (cord 40 extends to power source 50 after passing through inside wall 24, wherein this part of cord 40 is hidden from view due to inside wall 24), which includes battery or other electrical source, amplifier, and the like.

In some embodiments, adapter 42 is placed between cord 40 and player 18 in the event the connection point between cord 40 and player 18 do not match. Adapter 42 is any coupling device for connecting player 18 to cord 40.

In another embodiment, case 10 is wireless and therefore cord 40 is obviated. In this embodiment, audio or video information is transmitted from player 18 to speaker 28 via wireless transmission through known or novel manners. In some embodiments, a transmitter is placed between inside and outside walls 24, 26 for transmitting the audio or video information, or signal, from player 18 to speaker 28. The transmitter is placed next to power source 50.

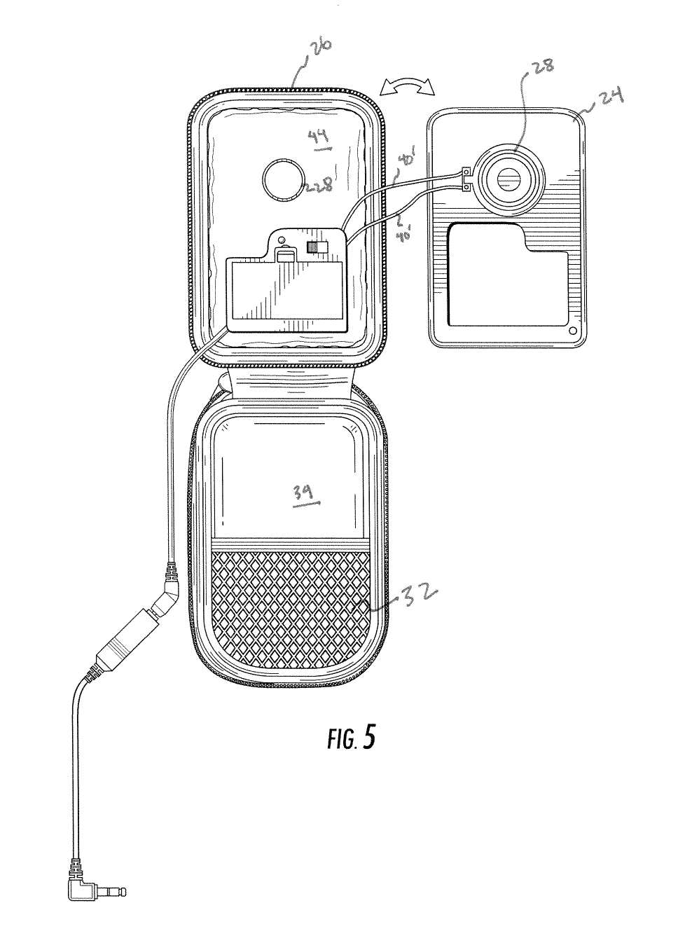

As shown in FIG. 5, front cover 20 includes inside wall 24 and outside wall 26. It is understood that in some instances back cover 30 includes the same limitations as front cover, such as inside wall 34 and outside wall 36. Speaker 28 is attached between inside and outside walls 24, 26. In further embodiments, speaker 28 faces toward outside wall 26 when inside and outside walls 24, 26 are assembled together. Moreover, cord 40 connects player 18 to power source 50 and cord 40′ connects power source 50 to speaker 28.

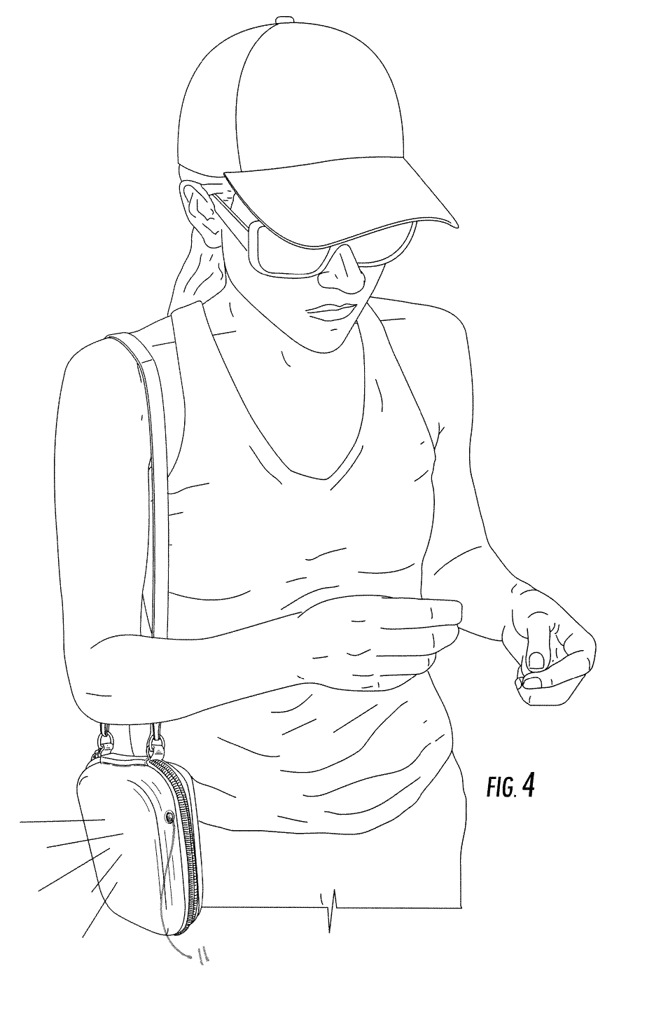

As shown in FIG. 4, the advantage of having speaker 28 facing toward outside wall 26 is so the user may listen to player 18 while case 10 is in the closed position. This is a benefit over the prior art, which tended to muffle sound emitted from player 18 when case 10 was in the closed position. As shown, cord 40 is inside case whether or not connected to player 18 so that it will not tangle with objects outside of case 10, thereby allowing the user to walk about with case 10 in an unencumbered manner.

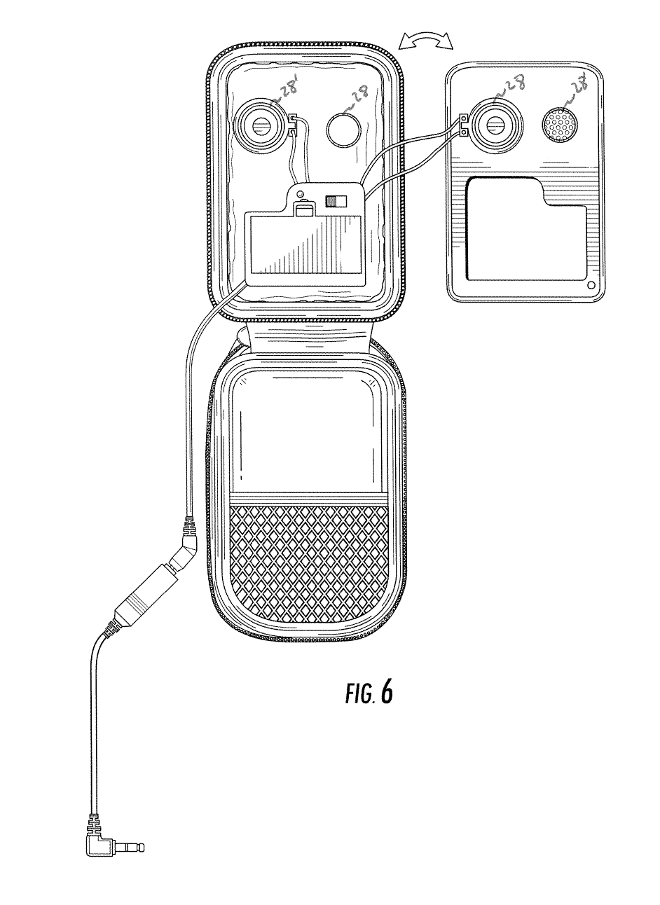

In a variation of this embodiment shown in FIG. 6, second speaker 28′ is placed between inside and outside walls 24, 26 of front cover 20, where second speaker 28′ faces toward inside wall 24. In this fashion, case 10 has optimal sound and/or audio emission whether or not case 10 is open or closed.

As shown in the figures, case 10 has rounded corners for providing a better fit for player 18. Front and back covers 20, 30 also include an outwardly bowed shape so that internal space is sufficient for player 18 yet the amount of play for player 18 to float about between inside walls 24, 34 is reduced.

In some embodiments, back cover 30 is without inside wall 34 or where inside wall 34 is directly contacting outside wall 36. In this fashion, front cover 20 includes power source 50 between inside and outside walls 24, 26 but back cover 30 is simply outside wall 36, and therefore has sufficient room for placement of player 18.

As shown in FIG. 4, the user listens to player 18 without headphones. Optionally, case 10 includes headphone jack 11 on the outside of case 10 so that player 18 can be listened with the user wearing headphones, in which case the headphones and cord from the headphones are located on the outside of case 10. This is beneficial if the user is using case 10 and listening to music from player 18 in an area where noise is undesired, such as an office or library.

As shown in FIG. 3, case 10 snugly holds player 18, which results in a reduction of player 18 floating around within case 10 and which further results in a reduction of damage to player 18. Also as shown, front and back covers 20, 30 each have rounded corners and a bowed outside wall curved outwardly for conforming to a shape and size of player 18. In some embodiments, case 10 fits around player 18 in such a snug fashion that the greatest distance from any point of case 10 to player 18 is less than 1 inch. In a preferred embodiment, the greatest distance from any point of case 10 to player 18 is less than ½ inch. In a more preferred embodiment, case 10 fits around player 18 in such a snug fashion that the greatest distance from any point of case 10 to player 18 is less than ¼ inch.

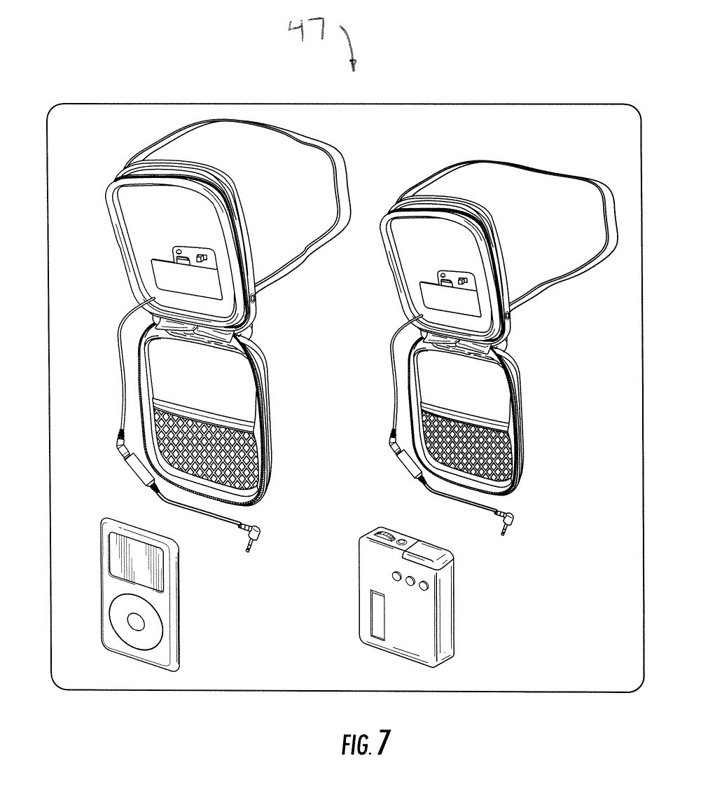

In another embodiment shown in FIG. 7, kit 47 of cases is provided, each case has a different dimension for holding a different sized player, such as a video player, iPod player, MP3 player, walkman player, discman player, and the like. The greatest distance between each case and each corresponding player includes the same limitations as the paragraph immediately above.

In some embodiments, the speaker is a NXT flat panel speaker. NXT panels generally include uniform dispersion characteristics, reduced room interaction, and a flat surface which can sit on the wall or even be integrated right into it (as with front cover 20).

In another embodiment shown in FIGS. 2 and 5, front and back covers 20, 30 includes layer 44 of electrically insulating material for reducing electric conductivity or shock from stray current, such as static or other ungrounded electric current that can damage player 18. In this manner, case 10 protects player 18 from mechanical shock, such as being dropped or dinged, as well as electrical shock, such as static electricity or other stray current.

As shown, layer 44 is between the inside and outside walls of each cover. In another embodiment, layer 44 of insulating material completely envelopes player 18 by covering the entire front and back covers 20, 30. In a further embodiment, holder 32 is also made of the insulating material. In another embodiment, layer 44 covers inside walls 24, 36.

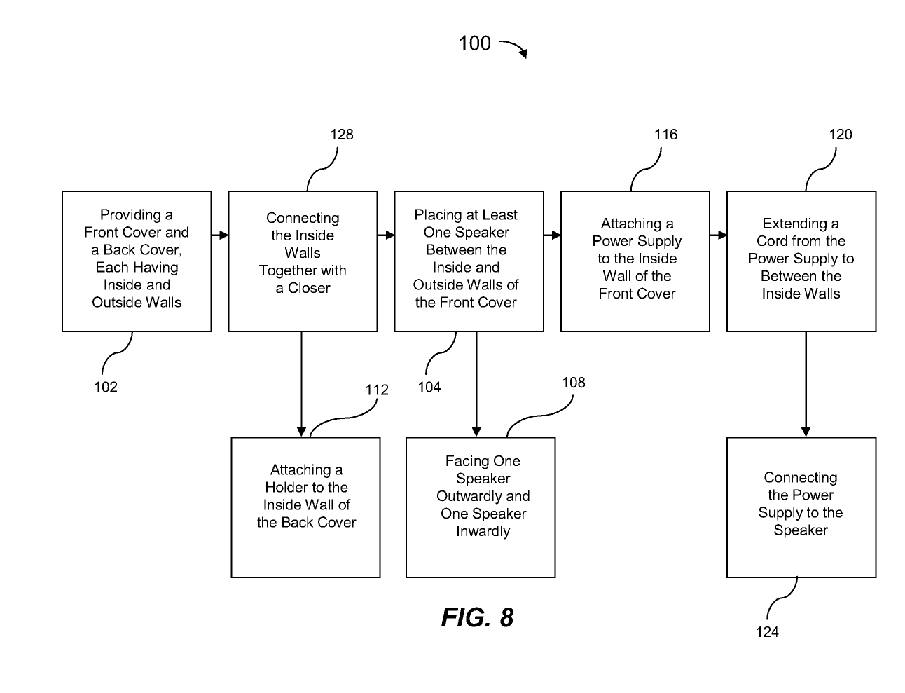

FIG. 8 depicts method 100 for providing the case for an audio or video player, where method 100 includes the steps of providing 102 a front cover and a back cover, each having an inside wall and an outside wall, and placing 104 at least one speaker between the inside and outside walls of the front cover.

Method 100 also includes the steps of facing 108 an output of the speaker toward the outside wall so that sound is optimized when the case is closed, attaching 112 a holder to the inside wall of the back cover for securing the player, attaching 1 16 a power supply to the inside wall of the front cover for powering the speaker, and extending 120 a cord from the power supply to between the inside walls for connecting the speaker to the power supply.

Method 100 also connects 124 the power supply to the speaker for transmitting sound from the player, connects 128 the inside walls together with a closer, and wherein the closer brings the inside walls together for defining the case in a closed position face to face position and permitting the inside walls to be separated from each other for defining the case in an open position.

What is claimed is:

1. A case for an audio or video player, comprising:
a front cover and a back cover, each having an inside wall and an outside wall;
a speaker placed between said inside and outside walls of said front cover;
a cord placed between said inside walls for connecting said speaker to the player through said inside wall of said front cover; and
said speaker having an output facing toward said outside wall.

2. The case according to claim 1, further comprising an adapter attached to said cord for coupling the player to said cord.

3. The case according to claim 1, further comprising a holder attached to said inside wall of said back cover for holding the player against said back cover.

4. The case according to claim 1, further comprising a headphone jack attached to said outside wall of said front cover for accommodating a set of headphones.

5. The case according to claim 1, wherein said front and back covers each include a layer of insulating material for reducing electric conductivity.

6. The case according to claim 1, further comprising a second speaker between said inside and outside walls of said front cover and having an output facing toward said inside wall.

7. The case according to claim 1, wherein a greatest distance between said front cover and said back cover from the player is less than 1 inch.

8. The case according to claim 1, wherein said front and back covers each have rounded corners and a bowed outside wall for conforming to a shape and size of the player.

9. A case for an audio or video player, comprising:
a front cover and a back cover, each having an inside wall and an outside wall;
a speaker placed between said inside and outside walls of said front cover;
said speaker having an output facing toward said outside wall;
a holder attached to said inside wall of said back cover for securing the player;
a power supply attached to said inside wall of said front cover for powering said speaker;
said speaker connected to said power supply for transmitting sound from the player; and
a closer for securing said inside walls in a face to face position.

10. The case according to claim 9, further comprising a cord extending from said power supply to between said inside walls for connecting said speaker to said power supply;

11. The case according to claim 9, wherein said front and back covers are each curved outwardly away from said inside wall, thereby defining an interior in which the player is placed.

12. A method for providing a case for an audio or video player, comprising the steps of:
providing a front cover and a back cover, each having an inside wall and an outside wall;
placing a speaker between the inside and outside walls of the front cover;
facing an output of the speaker toward the outside wall;
attaching a holder to the inside wall of the back cover for securing the player;
attaching a power supply to the inside wall of the front cover for powering the speaker;
extending a cord from the power supply to between the inside walls for connecting the speaker to the power supply;
connecting the power supply to the speaker for transmitting sound from the player; and
connecting the inside walls together with a closer;
wherein the closer brings the inside walls together for defining the case in a closed position face to face position and permitting the inside walls to be separated from each other for defining the case in an open position.
